(19) United States
(12) Patent Application Publication
(10) Pub. No.: US 2017/0267120 A1
(43) Pub. Date: Sep. 21, 2017

(54) VEHICLE, BATTERY UNIT AND BATTERY CARRYING METHOD OF VEHICLE

(71) Applicant: Honda Motor Co.,Ltd., Tokyo (JP)

(72) Inventors: Daijiro TAKIZAWA, Saitama (JP); Hirokazu OGUMA, Saitama (JP)

(73) Assignee: Honda Motor Co.,Ltd., Tokyo (JP)

(21) Appl. No.: 15/447,133

(22) Filed: Mar. 2, 2017

(30) Foreign Application Priority Data
Mar. 15, 2016 (JP) 2016-051500

(51) Int. Cl. B60L 11/18; B60L 15/00; H01M 2/10; H01M 10/663; H01M 10/613; H01M 10/6562; H01M 10/6568; B60K 1/04; H01M 10/625

(52) U.S. Cl. CPC B60L 11/1877; B60K 1/04; B60L 15/007; B60L 11/1874; H01M 2/1083; H01M 10/625; H01M 10/613; H01M 10/6562; H01M 10/6568; H01M 10/663; B60K 2001/0422; B60K 2001/0433; H01M 2220/20

(57) ABSTRACT

A vehicle adapted to improve cooling capacity and a carrying capacity of two types of batteries and implementing miniaturization of a system including the batteries, a battery unit and a battery carrying method of the vehicle are provided. The vehicle (1) includes a first power storage element (11), a second power storage element (12) with output weight density superior to that of the first power storage element (11), a motor (9) driven by at least one of electric powers of the first and second power storage elements (11) and (12), where the first and second power storage elements (11) and (12) are disposed outside a passenger compartment (5) and disposed under the passenger compartment (5) along a vertical direction, and the second power storage element (12) is disposed at a front end along a front and rear direction of the vehicle compared to the first power storage element (11).

### CROSS-REFERENCE TO RELATED APPLICATION

This application claims the priority benefit of Japan application serial no. 2016-051500, filed on Mar. 15, 2016. The entirety of the above-mentioned patent application is hereby incorporated by reference herein and made a part of this specification.

### BACKGROUND OF THE INVENTION

Field of the Invention

The invention relates to a vehicle, a battery unit and a battery carrying method of a vehicle.

Description of Related Art

A vehicle having two driving batteries with different characteristics (for example, different charging capacities, etc.) has been developed, for example, in a patent literature 1, in the aforementioned vehicle, the two batteries are disposed at different positions of a vehicle body. Namely, a high-output type battery is disposed in a luggage trunk, and a high-capacity type battery is disposed outside a passenger compartment and is disposed on a bottom surface of the vehicle body.

### EXISTING TECHNICAL LITERATURE

### Patent Literature

[Patent literature 1] International publication No. 2013/030884

### SUMMARY OF THE INVENTION

### Problem to be Resolved by the Invention

Moreover, according to the technique recorded in the patent literature 1, since batteries are respectively disposed in a vehicle body in separation, respective cooling systems are required, and a whole scale and weight of the system are increased. Therefore, a problem of assembling tune increase is encountered.

The invention is provided to resolve the aforementioned problem, and the invention is directed to a vehicle capable of improving a cooling capacity and a carrying capacity of two types of batteries and implementing miniaturization of a system including the two types of batteries, a battery unit and a battery carrying method of the vehicle.

### Technical Means for Resolving the Problem

(1) In order to achieve the aforementioned effect, the invention provides a vehicle including a first power storage element; a second power storage element with an output weight density superior to that of the first power storage element; and a driving element, driven by at least one of electric power of the first power storage element and electric power of the second power storage element, where the first power storage element and the second power storage element are disposed outside a passenger compartment and disposed under the passenger compartment along a vertical direction, and the second power storage element is disposed at a front end along a front and rear direction of the vehicle compared to the first power storage element.

(2) Moreover, the vehicle of the invention has a following structure, i.e. the first power storage element and the second power storage element are accommodated in a same frame.

(3) Moreover, the vehicle of the invention includes a single cooling loop for cooling the first power storage element and the second power storage element, where an internal resistance of the first power storage element is greater than an internal resistance of the second power storage element, and the cooling loop sequentially cools the second power storage element and the first power storage element.

(4) Moreover, the vehicle of the invention includes a front seat and a back seat disposed in the passenger compartment, where a volume of the first power storage element is greater than a volume of the second power storage element, and the second power storage element is disposed under the front seat along the vertical direction, and the first power storage element is disposed under the back seat along the vertical direction.

(5) Moreover, the vehicle of the invention includes a power conversion element for converting electric power between at least one of the first power storage element and the second power storage element and a power system outside the vehicle, and the power conversion element is configured in a manner of overlapping with the first power storage element along a left and right direction of the vehicle.

(6) Moreover, in the vehicle of the invention, the first power storage element, the second power storage element and the power conversion element are accommodated in a same frame.

(7) Moreover, the vehicle of the invention includes a connection element, serving as an electrical contact between the power conversion element and the power system, where the connection element is disposed at one of a left side surface and a right side surface of the vehicle close to the power conversion element.

(8) In order to achieve the aforementioned effect, the invention provides a battery unit including a first power storage element; a second power storage element with an output weight density superior to that of the first power storage element; a support member disposed outside a passenger compartment of a vehicle and located under the passenger compartment along a vertical direction, and adapted to integrally support the first power storage element and the second power storage element under a state that the second power storage element is disposed at a front end along a front and rear direction of the vehicle compared to the first power storage element.

(9) In order to achieve the aforementioned effect, the invention provides a battery carrying method of a vehicle, adapted to integrally support a first power storage element and a second power storage element to produce a battery unit under a state that the second power storage element with an output weight density superior to that of the first power storage element is disposed at a front end along a front and rear direction of the vehicle compared to the first power storage element, and install the battery unit to the outside of the passenger compartment along a vertical direction from underneath of the vehicle.

### Effect of the Invention

According to the structure of (1), the first power storage element and the second power storage element are disposed outside the passenger compartment and located under the passenger compartment along a vertical direction, such that a space inside the passenger compartment is wide, and the first power storage element and the second power storage element can be integrally installed, so as to reduce an assembling time required for assembling the power storage elements to a vehicle body. Moreover, since the first power storage element and the second power storage element do not require a respective cooling loop, miniaturization of the system becomes possible. Moreover, since the second power storage element is disposed in front of the first power storage element, even if only a driving wind is adopted to cool the first power storage element and the second power storage element, the driving wind used for cooling the second power storage element with less heating amount can be used for cooling the first power storage element with more heating amount. Therefore, compared to the situation of conducting the cooling in an inverse sequence, the two power storage elements can be effectively cooled down.

According to the structure of (2), the first power storage element and the second power storage element are accommodated in the same frame, such that the assembling time required for assembling the first power storage element and the second power storage element to the vehicle body can be greatly reduced. Moreover, by making a refrigerant to flow inside the frame, the first power storage element and the second power storage element can be easily cooled.

According to the structure of (3), after the second power storage element with a small internal resistance and less heating amount is first cooled, and then the first power storage element with a large internal resistance and more heating amount is cooled, such that the first power storage element and the second power storage element can be effectively cooled. Therefore, compared to the situation of conducting the cooling in an inverse sequence, the two power storage elements can be effectively cooled.

According to the structure of (4), since the first power storage element with a larger volume is disposed under the back seat and the second power storage element with a smaller volume is disposed under the front seat, not only a power storage capacity is ensured, but also a large space of the front seat with a higher usage frequency is also ensured.

According to the structure of (5), in the space outside the passenger compartment created for accommodating the first power storage element and the second power storage element, the power conversion element, the first power storage element and the second power storage element can be altogether disposed under a floor panel, such that a carrying capacity is increased, and compared to the situation that the power conversion element is not configured, or the power conversion element is independently disposed in the luggage trunk, a time for external power supply is greatly decreased.

According to the structure of (6), the first power storage element, the second power storage element and the power conversion element are accommodated in the same frame, such that the assembling time required for assembling the first power storage element, the second power storage element and the power conversion element is greatly decreased.

According to the structure of (7), the connection element is disposed at one of the left and the right side surfaces of the vehicle close to the power conversion element, such that the power conversion element and the connection element can be configured by closing to each other, so as to achieve wiring saving.

According to the structures of (8) and (9), the first power storage element and the second power storage element can be integrally installed to the vehicle body, such that the assembling time is reduced. Moreover, the first power storage element and the second power storage element do not require the respective cooling loop, and since the second power storage element is disposed in front of the first power storage element, even if only the driving wind is adopted to cool the first power storage element and the second power storage element, the driving wind used for cooling the second power storage element with less heating amount can be used for cooling the first power storage element with more heating amount.

In order to make the aforementioned and other features and advantages of the invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a left side view of a vehicle according to a first embodiment of the invention.

FIG. 2 is a right side view of the vehicle according to the first embodiment of the invention.

FIG. 3 is a three-dimensional view of a battery unit of the vehicle.

FIG. 4 is a plane diagram of the battery unit of the vehicle.

FIG. 5 is a left side view of a vehicle according to a second embodiment of the invention.

FIG. 6 is a left side view of a vehicle according to a third embodiment of the invention.

FIG. 7 is a left side view of a vehicle according to a fourth embodiment of the invention.

FIG. 8 is a left side view of a vehicle according to a fifth embodiment of the invention.

### DESCRIPTION OF EMBODIMENTS

Reference will now be made in detail to the present preferred embodiments of the invention. Moreover, directions of front, rear, left and right mentioned in the following specification are the same to the following directions of the vehicle body in the following description as long as the direction is not particularly specified. An arrow FR represents front of the vehicle body, and an arrow UP represents the top of the vehicle body.

### First Embodiment

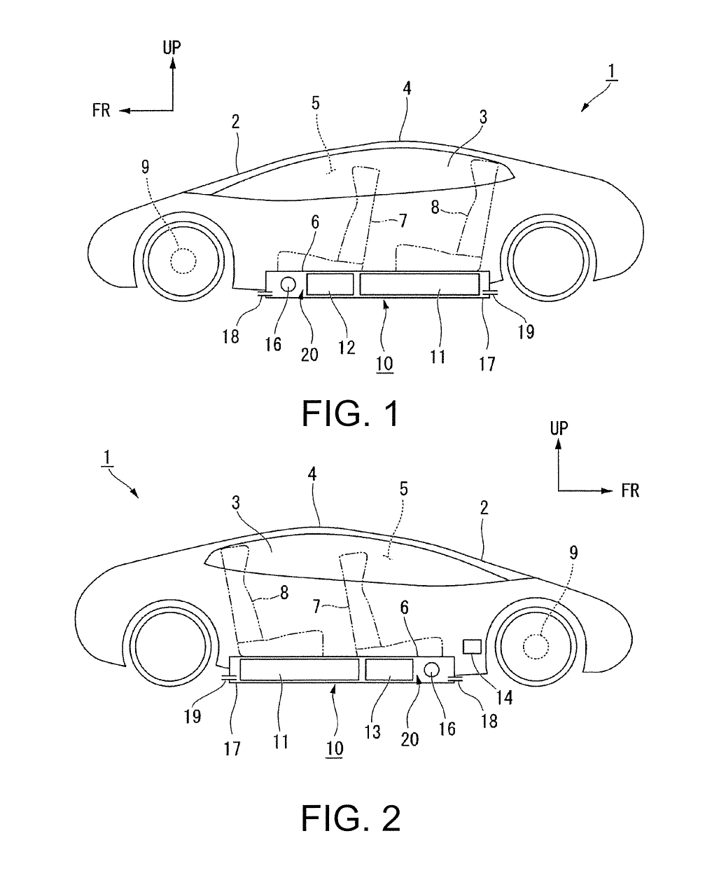

As shown in FIG. 1, the vehicle 1 has a passenger compartment 5 encircled by a front window glass 2, left and right side window glass 3, and a roof 4. The vehicle 1 has a front seat 7 and a back seat 8 for passengers on a floor panel 6 and in the passenger compartment 5.

The vehicle 1 is an electric vehicle (EV), which has a motor (a driving element) 9 used for driving and a battery (a first power storage element 11 and a second power storage element 12). The motor 9 is driven by electric power of at least one of the first power storage element 11 and the second power storage element 12. Besides an alternating current (AC) motor or a direct current (DC) motor disposed in an engine room located at a front portion of the vehicle body, the motor 9 can also be an in wheel motor. Besides that the vehicle 1 is a battery type EV only using the energy of the battery to drive the motor 9, the vehicle 1 can also be a hybrid car using both of electricity and an engine (internal combustion engine) for driving, or a fuel cell vehicle using fuel cells to generate electricity.

The vehicle 1 is configured with a battery unit 10 outside the passenger compartment 5 and on a lower surface of the floor panel 6 (in other word, outside the passenger compartment 5 and under the passenger compartment 5 along a vertical direction). The battery unit 10 includes the first power storage element 11 and the second power storage element 12 with different charging capacities.

The first power storage element (ES-E) 11 is a high-capacity type battery, and the second power storage element (ES-P) 12 is a high-output type battery. The second power storage element 12 has an energy weight density inferior to that of the first power storage element 11 and has an output weight density superior to that of the first power storage element 11. The first power storage element 11 has a higher energy capacity compared to the second power storage element 12. In order to ensure a driving distance, the first power storage element 11 is preferably designed to have a size greater than that of the second power storage element 12. The first power storage element 11 has a width equivalent to a full left-right width of the back seat 8 and is located under the back seat 8 along the vertical direction. The first power storage element 11 is formed by stacking a plurality of battery blocks where a height of a front portion is higher than a height of a rear portion. An internal resistance of the first power storage element 11 is greater than that of the second power storage element 12, and thus the first power storage element 11 is easily to be in a high temperature.

Though the second power storage element 12 is smaller than the first power storage element 11 in size, the second power storage element 12 can be charged and discharged in a current greater than that of the first power storage element 11. The second power storage element 12 is disposed under a left side of the front seat 7 along the vertical direction. Namely, the second power storage element 12 is disposed in the front along a front and rear direction of the vehicle compared to the first power storage element 11.

The first power storage element 11 and the second power storage element 12 are respectively constructed by connecting a plurality of battery blocks (not shown) in series. The number of the battery blocks or the number of battery cells contained in each of the battery blocks are determined with reference of required output or capacity, etc., of each of the first power storage element 11 and the second power storage element 12. The battery cell can be implemented by a secondary battery such as a nickel-metal hydride battery or a lithium ion battery.

By using the two power storage elements 11 and 12 with different characteristics, and through following characteristic control of each of the power storage elements 11 and 12, for example, the first power storage element 11 is discharged in a fixed power that is not determined by a required power of the motor 9, and the second power storage element 12 is charged and discharged in a rate based on a difference between the fixed power and the required power, such that the two power storage elements 11 and 12 may serve as an ideal power storage element with a high energy density and high power density that is hard to be achieved by a single power storage element. Compared to the power storage element that only has one of the characteristics of high capacity or high output, the above ideal power storage element has advantages in weight, volume and cost.

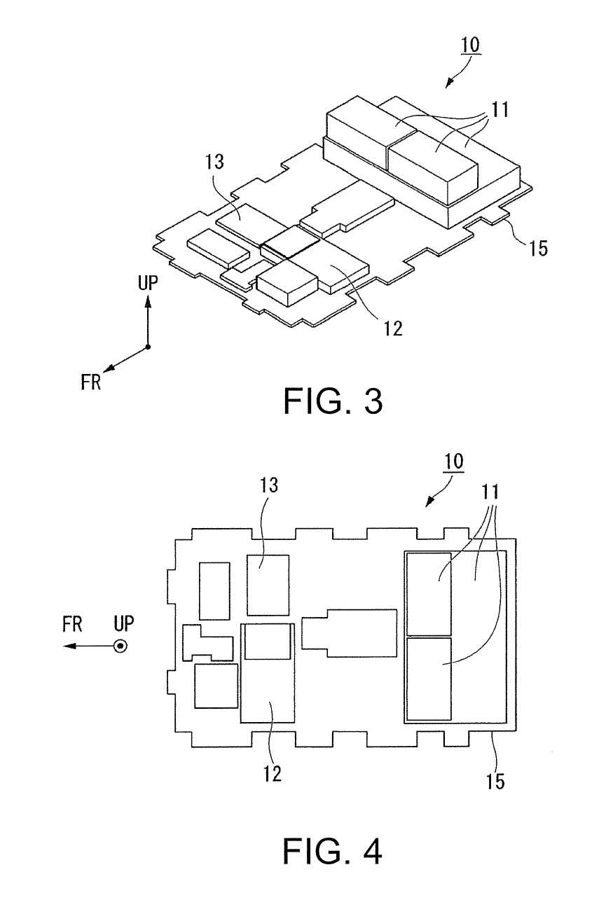

Referring to FIG. 1-FIG. 4, besides the first power storage element 11 and the second power storage element 12, the battery unit 10 further has a power conversion element 13, a connection element 4, a support member 15, a fan 16 and a frame 17.

The power conversion element 13 performs power conversion between at least one of the first power storage element 11 and the second power storage element 12 and a power system outside the vehicle 1. The power conversion element 13 is disposed under a right side of the front seat 7 along the vertical direction, and is located adjacent to a right side of the second power storage element 12. Namely, the power conversion element 13 is disposed in a manner of overlapping with the first power storage element 11 along a left and right direction of the vehicle 1.

The connection element 14 is a charging connector, which is disposed at a same side (the right side) with the power conversion element 13 in the left and right direction of the vehicle, and is exposed to a right side surface of the vehicle through a lid, etc. Namely, the connection element 14 is disposed at one of the left and the right side surfaces of the vehicle close to the power conversion element 13. The connection element 14 can also be disposed adjacent to or integrally with the power conversion element 13.

The support member 15 is a base plate used for integrally carrying various devices of the battery unit 10 in the frame 17. Besides the first power storage element 11, the second power storage element 12 and the power conversion element 13, the support member 15 further supports an inverter connected to the motor 9, a boost converter disposed between the first power storage element 11, the power conversion element 13 and the inverter, a boost converter disposed between the second power storage element 12 and the inverter, and various controllers and a junction box (which are not shown).

The frame 17 is, for example, made of resin or metal and has a box shape, and has a flat shape with a height size adapted to be disposed to the outside of the passenger compartment 5 and under the floor panel 6. The frame 17 is fixed on the support member 15 to cover the components within the frame, so as to form a box shape. The frame 17 has an external gas inlet port 18 opening towards the front side of the vehicle outside the passenger compartment 5 and an external gas outlet port 19 opening towards the rear side of the vehicle outside the passenger compartment 5. Through the external gas inlet port 18, the external gas outlet port 19 and the fan 16 and the frame 17, a single cooling loop 20 used for cooling the first power storage element 11 and the second power storage element 12 is formed in the frame 17.

When the battery unit 10 is installed on a lower surface of the floor panel 6, from the front side to the rear side along the front and rear direction of the vehicle, the frame 17 sequentially accommodates the fan 16, the second power storage element 12 and the power conversion element 13, and the first power storage element 11. Namely, the first power storage element 11 and the second power storage element 12 are disposed to the outside of the passenger compartment 5 and located under the passenger compartment 5 along the vertical direction, and the second power storage element 12 is disposed in the front end of the vehicle compared to the first power storage element 11 along the front and read direction of the vehicle.

In the frame 17, the driving wind can be inlet from the external gas inlet port 18, and after sequentially cooling the second power storage element 12 and the first power storage element 11, the driving wind is exhausted rearward through the external gas outlet port 19. In the frame 17, even if the vehicle 1 is in a stop state, the external gas can be inlet from the external gas inlet port 18 through driving of the fan 16, and the external gas sequentially cools the second power storage element 12 and the first power storage element 11, and is exhausted rearward through the external gas outlet port 19. The fan 16 is an electric fan, which is, for example, driven by the electric power of at least one of the first power storage element 11 and the second power storage element 12. In the example of FIG. 1, the fan 16 is disposed near the external gas inlet port 18, and directly draws the external gas from the external gas inlet port 18 for inletting to the frame 17. Moreover, a following structure can also be adopted: the fan 16 is disposed near the external gas outlet port 19 to produce a negative pressure in the frame 17, so as to inlet the external gas froth the external gas inlet port 18.

Regarding the battery unit 10, the support member 15 is adopted to integrally support the first power battery element 11, the second power battery element 12, the power conversion element 13 and the fan 16, etc., and then frame internal members are covered on the support member 15 to form the box-shape frame 17, so as to form an integral unit that accommodates various devices within the frame 17. Under the state that the battery unit 10 is installed to the vehicle 1, the second power storage element 12 is disposed at the front end of the vehicle compared to the first power storage element 11.

The battery unit 10 is installed to the outside of the passenger compartment 5 along the vertical direction from the underneath of the vehicle 1. In this way, installation of the driving batteries (the power storage elements 11 and 12) and related devices to the vehicle 1 becomes easier. By installing each of the power storage elements 11 and 12 to the outside of the passenger compartment 5 and under the passenger compartment 5 along the vertical direction, influence on an internal space of the passenger compartment 5 is suppressed, and a center of gravity of the vehicle 1 is lowered.

In the battery unit 10, by configuring the second power storage element 12 with less heating amount at an upstream side of the cooling loop 20 compared to the first power storage element 11 with more heating amount, each of the power storage elements 11 and 12 can be cooled in high efficiency by using a refrigerant (the external gas). In the battery unit 10, by configuring the second power storage element 12 to the front end of the vehicle 1 compared to the first power storage element 11, as long as the driving wind is inlet to the frame 17, each of the power storage elements 11 and 12 can be cooled in high efficiency by using the driving wind. Namely, upper limit temperatures of the first power storage element 11 and the second power storage element 12 in cooling are the same, and even the driving wind used for cooling the second power storage element 12 with less heating amount can be used to adequately cool the first power storage element 11. However, in case that the sequence of the first power storage element 11 and the second power storage element 12 is changed, the aforementioned effect cannot be achieved.

According to the above description, in the embodiment of the invention, since the first power storage element 11 and the second power storage element 12 are disposed to the outside of the passenger compartment 5 and disposed under the passenger compartment 5 along the vertical direction, a wider internal space of the passenger compartment is ensured, and the first power storage element 11 and the second power storage element 12 can be integrally installed, such that an assembling time required for assembling the same to the vehicle body is decreased.

Moreover, since the high output type battery with a smaller volume, i.e. the second power storage element 12 is disposed in at a front side of the passenger compartment 5 (i.e. at the side of the front seat 7), a wider space around the front seat 7 is ensured. Moreover, since the high capacity type battery with a larger volume, i.e. the first power storage element 11 is disposed at a back side of the passenger compartment 5 (i.e. at the side of the back seat 8), together with a luggage trunk space, a wider configuration space for the high capacity type battery is ensured.

Moreover, since the first power storage element 11 and the second power storage element 12 do not require the respective cooling loop, miniaturization and light weight of the system can be implemented. Moreover, since the second power storage element 12 is disposed in the front compared to the first power storage element 11, even when the driving wind is used to cool the first power storage element 11 and the second power storage element 12, the driving wind used for cooling the second power storage element 12 with less heating amount can be further used to cool the first power storage element 11 with more heating amount.

Moreover, according to the present embodiment, the first power storage element 11 and the second power storage element 12 are accommodated in the same frame 17, so that the assembling time required for assembling the first power storage element 11 and the second power storage element 12 to the vehicle body can be greatly reduced. Moreover, as the refrigerant flows inside the frame 17, the first power storage element 11 and the second power storage element 12 cab be easily cooled.

Moreover, according to the present embodiment, the cooling loop 20 implements cooling according to the sequence of the second power storage element 12 and the first power storage element 11, where the second power storage element 12 with smaller internal resistance and less heating amount is first cooled, and then the first power storage element 11 with larger internal resistance and more heating amount is cooled, so that the first power storage element 11 and the second power storage element 12 can be effectively cooled.

Moreover, according to the present embodiment, since the second power storage element 12 with a smaller volume is disposed under the front seat 7 along the vertical direction, and the first power storage element 11 with a larger volume is disposed under the back seat 8 along the vertical direction, not only a power storage capacity is ensured, but also a wider space of the front seat 7 with a higher usage frequency is ensured.

Moreover, according to the present embodiment, since the power conversion element 13 used for converting power between the first power storage element 11, the second power storage element 12 and the external power system is disposed in a manner of overlapping with the first power storage element 11 along a left and right direction of the vehicle, the power conversion element 13 and the first power storage element 11, the second power storage element 12 can be altogether disposed under the floor panel, so as to increase a loading capacity, and compared to the situation that the power conversion element is not configured, or the power conversion element is independently disposed in the luggage trunk, a time for external power supply is greatly decreased.

Moreover, according to the present embodiment, the first power storage element 11, the second power storage element 12 and the power conversion element 13 are accommodated in the same frame 17, so that the assembling time required for assembling the first power storage element 11, the second power storage element 12 and the power conversion element 13 is greatly decreased.

Moreover, according to the present embodiment, the connection element 14 serving as an electrical contact between the power conversion element 13 and the external power system is disposed at one of the left and the right side surfaces of the vehicle close to the power conversion element 13, such that the power conversion element 13 and the connection element 14 can be configured by closing to each other, so as to achieve wiring saving.

### Second Embodiment

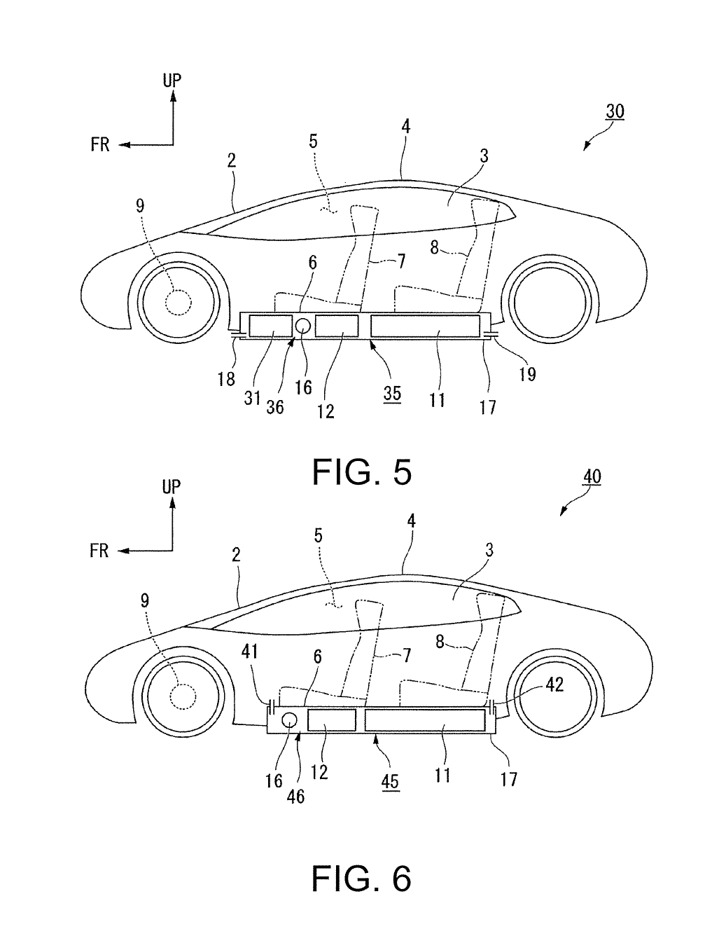

Then, the second embodiment of the invention is described below with reference of FIG. 5.

Compared to the first embodiment, a difference of a vehicle 30 and a battery unit 35 of the present embodiment is that an evaporator 31 is configured at the external gas inlet port 18. Other structures that are the same or similar to that of the aforementioned embodiment are denoted by the same reference numbers, and descriptions of the same technical contents are omitted.

The evaporator 31 is, for example, a heat exchanger using an air conditioning refrigerant of the vehicle 30 to cool the air, and is disposed in the frame 17 close to the back (a downstream side) of the external gas inlet port 18, and is disposed in front of (an upstream side) each of the power storage elements 11 and 12. In the example of FIG. 5, the fan 16 is disposed between the evaporator 31 and each of the power storage elements 11 and 12. Through the external gas inlet port 18, the external gas outlet port 19, the fan 16, the evaporator 31 and the frame 17, a single cooling loop 36 used for cooling the first power storage element 11 and the second power storage element 12 is formed in the frame 17. In this way, the external gas inlet to the frame 17 through the external gas inlet port 18 is cooled by the evaporator 31, and each of the power storage elements 11 and 12 located at the downstream side are effectively cooled.

### Third Embodiment

Then, the third embodiment of the invention is described below with reference of FIG. 6.

Compared to the first embodiment, a difference of a vehicle 40 and a battery unit 45 of the present embodiment is that the frame 17 has an indoor gas inlet port 41 and an indoor gas outlet port 42 opening towards the passenger compartment 5 to replace the external gas inlet port 18 and the external gas outlet port 19. Other structures that are the same or similar to that of the aforementioned embodiment are denoted by the same reference numbers, and descriptions of the same technical contents are omitted.

In the dame 17, the air in the passenger compartment 5 can be inlet from the indoor gas inlet port 41, and after the second power storage element 12 and the first power storage element 11 are sequentially cooled by the air, the air is exhausted to the passenger compartment 5 through the indoor gas outlet port 42. Through the indoor gas inlet port 41, the indoor gas outlet port 42, the fan 16 and the frame 17, a single cooling loop 46 used for cooling the first power storage element 11 and the second power storage element 12 is formed in the frame 17. The air in the passenger compartment 5 is stable in temperature compared to the external gas, such that it is easy to maintain the cooling performance of each of the power storage elements 11 and 12.

### Fourth Embodiment

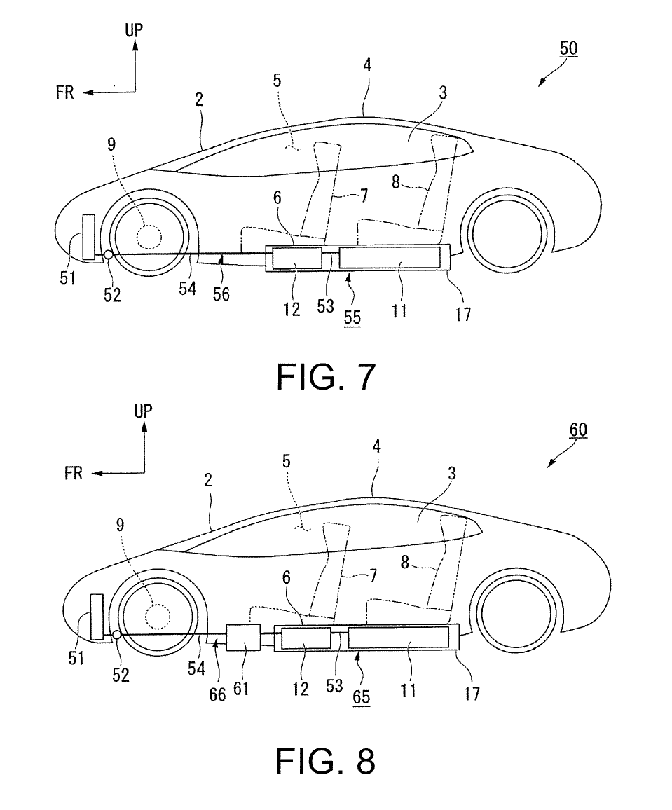

Then, the fourth embodiment of the invention is described below with reference of FIG. 7.

Compared to the aforementioned embodiments, a difference of a vehicle 50 and a battery unit 55 of the present embodiment is that each of the power storage elements 11 and 12 are set to water cooling. Other structures that are the same or similar to that of the aforementioned embodiment are denoted by the same reference numbers, and descriptions of the same technical contents are omitted.

The vehicle 50 has a refrigerant flow path 53 disposed in the frame 17 and adapted to cool each of the power storage elements 11 and 12; a radiator 51 disposed at, for example, a front end of the vehicle 50; a connection flow path extending between the radiator 51 and the refrigerant flow path 53; and an electric water pump 52 adapted to make a cooling water to cycle between the radiator 51 and the refrigerant flow path 53. Through the frame 17, the refrigerant flow path 53, the radiator 51, the connection flow path 54 and the water pump 52, a single cooling loop 56 used for cooling the first power storage element 11 and the second power storage element 12 is formed in the frame 17.

In this way, the cooling performance of each of the power storage elements 11 and 12 is easy to be improved compared to the embodiment of setting each of the power storage elements 11 and 12 to air cooling.

### Fifth Embodiment

Then, the fifth embodiment of he invention is described below with reference of FIG. 8.

Compared to the vehicle 50 of the fourth embodiment, a difference of a vehicle 60 and a battery unit 65 of the present embodiment is that a chiller 61 used for. cooling the cooling water is configured. Other structures that are the same or similar to that of the aforementioned embodiment are denoted by the same reference numbers, and descriptions of the same technical contents are omitted.

The chiller 61 is, for example, a heat exchanger using the air conditioning refrigerant of the vehicle 60 to cool the cooling water, and is, for example, disposed between the water pump 52 and the frame 17 on the connection flow path 54. The chiller 61 cools the cooling water that is inlet to the refrigerant flow path 53 in the frame 17 from the radiator 51, so as to effectively cool each of the power storage elements 11 and 12 located at the downstream side. Through the frame 17, the refrigerant flow path 53, the radiator 51, the connection flow path 54, the chiller 61 and the water pump 52, a single cooling loop 66 used for cooling the first power storage element 11 and the second power storage element 12 is formed in the frame 17. In this way, the cooling performance of each of the power storage elements 11 and 12 is improved compared to the fourth embodiment.

Moreover, the invention is not limited to the aforementioned embodiments, and various modifications can be made without departing from the spirit of the invention. For example, in the example of FIG. 6, the evaporator 31 of FIG. 5 can also be configured. As long as the chiller 61 is located at the upstream side compared to each of the power storage elements 11 and 12, the chiller 61 can also be disposed in the frame 17, and a location thereof can be overlapped with each of the power storage elements 11 and 12.

The seats configured in the passenger compartment 5 are not limited to the front seat 7 and the back seat 8, and the back seat 8 can be designed to have two rows of seats. The external gas inlet port 18 formed in the frame 17 can also be formed integrally with an under cover covering a lower surface of the vehicle.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A vehicle, comprising:
a first power storage element;
a second power storage element, with an output weight density superior to that of the first power storage element; and
a driving element, driven by at least one of electric power of the first power storage element and electric power of the second power storage element,
wherein the first power storage element and the second power storage element are disposed outside a passenger compartment and disposed under the passenger compartment along a vertical direction, and
the second power storage element is disposed at a front end along a front and rear direction of the vehicle compared to the first power storage element.

2. The vehicle as claimed in claim 1, wherein the first power storage element and the second power storage element are accommodated in a same frame.

3. The vehicle as claimed in claim 1, further comprising:
a single cooling loop, cooling the first power storage element and the second power storage element,
wherein an internal resistance of the first power storage element is greater than an internal resistance of the second power storage element, and
the cooling loop sequentially cools the second power storage element and the first power storage element.

4. The vehicle as claimed in any one of the claims 1, further comprising:
a front seat and a back seat, disposed in the passenger compartment,
wherein a volume of the first power storage element is greater than a volume of the second power storage element,
the second power storage element is disposed under the front seat along the vertical direction, and
the first power storage element is disposed under the back seat along the vertical direction.

5. The vehicle as claimed in any one of the claims 3, further comprising:
a front seat and a back seat, disposed in the passenger compartment,
wherein a volume of the first power storage element is greater than a volume of the second power storage element,
the second power storage element is disposed under the front seat along the vertical direction, and
the first power storage element is disposed under the back seat along the vertical direction.

6. The vehicle as claimed in any one of the claims 1, further comprising:
a power conversion element, converting electric power between at least one of the first power storage element and the second power storage element and a power system outside the vehicle,
wherein the power conversion element is configured in a manner of overlapping with the first power storage element along a left and right direction of the vehicle.

7. The vehicle as claimed in any one of the claims 3, further comprising:
a power conversion element, converting electric power between at least one of the first power storage element and the second power storage element and a power system outside the vehicle,
wherein the power conversion element is configured in a manner of overlapping with the first power storage element along a left and right direction of the vehicle.

8. The vehicle as claimed in any one of the claims 4, further comprising:
a power conversion element, converting electric power between at least one of the first power storage element and the second power storage element and a power system outside the vehicle,
wherein the power conversion element is configured in a manner of overlapping with the first power storage element along a left and right direction of the vehicle.

9. The vehicle as claimed in any one of the claims 5, further comprising:
a power conversion element, converting electric power between at least one of the first power storage element and the second power storage element and a power system outside the vehicle,
wherein the power conversion element is configured in a manner of overlapping with the first power storage element along a left and right direction of the vehicle.

10. The vehicle as claimed in claim 6, wherein the first power storage element the second power storage element and the power conversion element are accommodated in a same frame.

11. The vehicle as claimed in claim 7, wherein the first power storage element, the second power storage element and the power conversion element are accommodated in a same frame.

12. The vehicle as claimed in claim 8, wherein the first power storage element, the second power storage element and the power conversion element are accommodated in a same frame.

13. The vehicle as claimed in claim 9, wherein the first power storage element, the second power storage element and the power conversion element are accommodated in a same frame.

14. The vehicle as claimed in claim 6, further comprising:
a connection element, serving as an electrical contact between the power conversion element and the power system,
wherein the connection element is disposed at one of a left side surface and a right side surface of the vehicle close to the power conversion element.

15. The vehicle as claimed in claim 7, further comprising:
a connection element, serving as an electrical contact between the power conversion element and the power system,
wherein the connection element is disposed at one of a left side surface and a right side surface of the vehicle close to the power conversion element.

16. The vehicle as claimed in claim 8, further comprising:
a connection element, serving as an electrical contact between the power conversion element and the power system,
wherein the connection element is disposed at one of a left side surface and a right side surface of the vehicle close to the power conversion element.

17. The vehicle as claimed in claim 9, fu her comprising:
a connection element, serving as an electrical contact between the power conversion element and the power system,
wherein the connection element is disposed at one of a left side surface and a right side surface of the vehicle close to the power conversion element.

18. A battery unit, comprising:
a first power storage element;
a second power storage element, with an output weight density superior to that of the first power storage element; and
a support member, disposed outside a passenger compartment of a vehicle and located under the passenger compartment along a vertical direction, and adapted to integrally support the first power storage element and the second power storage element under a state that the second power storage element is disposed at a front end along a front and rear direction of the vehicle compared to the first power storage element.

19. A battery carrying method of a vehicle, comprising:
integrally supporting a first power storage element and a second power storage element to produce a battery unit under a state that the second power storage element with an output weight density superior to that of the first power storage element is disposed at a front end along a front and rear direction of the vehicle compared to the first power storage element, and installing the battery unit to the outside of the passenger compartment along a vertical direction from underneath of the vehicle.
